(19) United States
(12) Patent Application Publication
(10) Pub. No.: US 2009/0195408 A1
(43) Pub. Date: Aug. 6, 2009

(54) METHODS AND APPARATUS FOR HIGH-SPEED TELEMETRY WHILE DRILLING

(75) Inventors: Douglas J. Patterson, Spring, TX (US); David H. Lilly, Houston, TX (US); James V. Leggett, III, Magnolia, TX (US); Michael Neubert, Braunschweig (DE); Kiattisak Petpisit, Houston, TX (US); Volker Krueger, Celle (DE); Holger Mathiszik, Eicklingen (DE); Nigel R. Ryder, Houston, TX (US); James C. Jackson, Houston, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/187,769

(22) Filed: Aug. 7, 2008

Related U.S. Application Data
(60) Provisional application No. 60/968,799, filed on Aug. 29, 2007.

(51) Int. Cl. G01V 3/00

(52) U.S. Cl. 340/856.4

(57) ABSTRACT

A seismic and/or acoustic while drilling configuration includes a high speed telemetry arrangement; at least one seismic and/or acoustic energy sensor in communication with the high speed telemetry arrangement; at least one seismic and/or acoustic energy source capable of producing at least one seismic and/or acoustic energy signal receivable by the at least one seismic and/or acoustic energy sensor and methods.

### CROSS REFERENCE TO RELATED APPLICATION

The present application claims priority to U.S. Provisional Patent Application Ser. No. 60/968,799, filed Aug. 29, 2007, the entire contents of which are specifically incorporated herein by reference.

### BACKGROUND

Geophysical exploration is an important part of the hydrocarbon recovery industry. Seismic and/or acoustic measurements and monitoring have long been viewed as a particularly effective means for measuring and monitoring the geophysical and reservoir environment downhole.

Commonly, seismic and/or acoustic information is gained from the wellbore either through a wireline tool in real time or in LWD more recently through processing and storage of received information at the downhole tool. In LWD a small subset of this information may be pulsed uphole, for example, with some delay in time due to limited bandwidth. The total recorded information is later brought to the surface for downloading and analysis. While wireline provides for a number of different functions in real time within the wellbore, the wireline itself occludes the flow passage within a string in which it is placed. Further, wireline measurements are acquired only after a well has been drilled to certain depth and therefore wireline is not effective to address the “while drilling” needs. Because of the occlusion, other wellbore operations are significantly hindered during a wireline testing process. Nevertheless wireline testing has been the gold standard for a substantial period of time where a borehole seismic and/or acoustic measurement is desired.

Where wireline is not the tool of choice, vibrations may be sent through the mud column or the drill string itself although compensation related to signal path velocity is required to determine the time value of the measurement. The method further suffers from having a limited bandwidth available. In such systems typically a seismic source would be located at the surface and transmit seismic energy in the downhole strata, which is recorded by sensors located downhole. The source does not need to be on the surface, however, as it maybe located downhole. Further, the source may be an acoustic source or noise created by a drill bit. This energy would then be measured at the sensor(s) either by a direct signal path or be reflected back to the sensors for the downhole measurement and stored there. In either event information is not rapidly obtained.

### SUMMARY

A seismic and/or acoustic while drilling configuration includes a high speed telemetry arrangement; at least one seismic and/or acoustic energy sensor in communication with the high speed telemetry arrangement; at least one seismic and/or acoustic energy source capable of producing at least one seismic and/or acoustic energy signal receivable by the at least one seismic and/or acoustic energy sensor.

A method for monitoring a wellbore while drilling includes measuring seismic and/or acoustic energy at a downhole location; transmitting a signal representative of the seismic and/or acoustic energy through a high-speed telemetry arrangement to a remote location.

A method for monitoring a formation while drilling includes stopping movement of the drill string; listening for sounds of the formation without running an additional tool; recommencing movement of the drill string.

A method for 4D monitoring a formation after drilling includes introducing into a seismic and/or acoustic while drilling configuration including a high speed telemetry arrangement; at least one seismic and/or acoustic energy sensor in communication with the high speed telemetry arrangement; at least one seismic and/or acoustic energy source capable of producing at least one seismic and/or acoustic energy signal receivable by the at least one seismic and/or acoustic energy sensor; initiating a seismic and/or acoustic signal from the seismic and/or acoustic source; and monitoring the signal over time.

A method for at least one of monitoring, adapting and operating in the wellbore while drilling includes introducing into a seismic and/or acoustic while drilling configuration including a high speed telemetry arrangement; at least one seismic and/or acoustic energy sensor in communication with the high speed telemetry arrangement; at least one seismic and/or acoustic energy source capable of producing at least one seismic and/or acoustic energy signal receivable by the at least one seismic and/or acoustic energy sensor; sending a signal over the high-speed telemetry arrangement to a sensor in the downhole environment; causing the sensor to deploy into contact with a target formation; measuring a parameter of the formation with the sensor; telemetering information measured by the sensor to a remote location.

### BRIEF DESCRIPTION OF THE DRAWINGS

Referring now to the drawings wherein like elements are numbered alike in the several Figures:

FIG. 1 is a schematic illustration of a drill string having a high-speed telemetry arrangement, a drill bit, seismic and/or acoustic source, and seismic and/or acoustic sensor.

### DETAILED DESCRIPTION

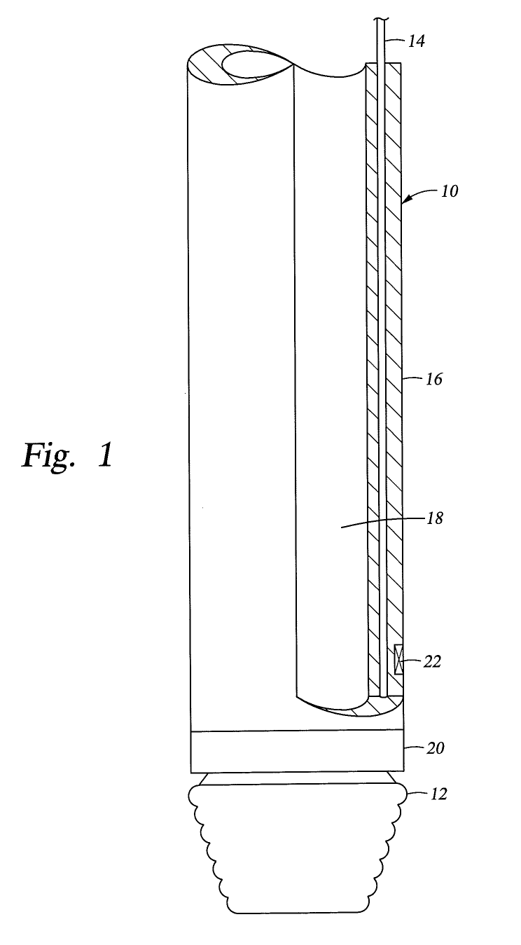

Referring to FIG. 1, a three-quarter sectional schematic view of a wired pipe 10 (a high-speed telemetry arrangement) and a drill bit 12 is presented for clarity of disclosure. A conductor 14 is illustrated and embedded within a thickness of a wall 16 of the wired pipe 10. A flow area 18 is illustrated as patent, there being no restriction due to, for example, a wireline or other more fixed configuration extending therein for the purpose of communication or sensing. In the configuration illustrated in FIG. 1, the conductor 14 enables high-speed telemetry such that real-time seismic and/or acoustic while drilling is both possible and enhanced in function. The high-speed telemetry capability allows the transmission of raw data or waveform, partially processed results or the initial final results or combinations of these over time as desired. This allows the operator to adjust various parameters including such things as the slowness results or tool operating parameters including but not limited to acquisition modes (e.g. changing of the quadrupole to high frequency for fast formations or the changing to a CBL (casing bond log) mode while in casing) and also allows control of the acquisition of for example acoustic data (depth based as opposed to time based). Configurations contemplated, then, include a seismic and/or acoustic source(s) at surface with seismic and/or acoustic receiver(s) downhole; seismic and/or acoustic receiver(s) at the surface and a seismic and/or acoustic source(s) downhole; and receiver(s) and source(s) downhole (where the source(s) is active or passive). Because of the high-speed telemetry capability, each of the configurations noted are possible where they were not possible prior to the configuration illustrated schematically in FIG. 1. Further, because of the high-speed telemetry capability, the traditional exceptionally accurate clock (not shown) that has been required in the downhole environment in order to obtain useful seismic and/or acoustic information is no longer required. The configuration of FIG. 1 allows for a less accurate clock to be used or even for the clock to be eliminated, which of course reduces costs in association with the gathering of seismic and/or acoustic information. Where a lower accuracy clock is retained, data received from the system can be improved by sending a synchronization signal from a remote location, such as the surface, where the seismic and/or acoustic source is located, to the downhole clock thereby synchronizing a surface clock and the downhole lower accuracy clock.

In addition to the foregoing, utilization of the configuration illustrated in FIG. 1 allows for the implementation of a seismic and/or acoustic source 20 in close proximity to the drill bit 12. Such a source may be active or passive but in either case because the source is proximate the drill bit 12, pipe string velocity no longer needs to be taken into account when rectifying information obtained through sensory monitoring. Further, a passive seismic and/or acoustic source can be the drill bit itself (creating a pilot or true reference signal) with a sensor positioned as schematically illustrated at 22. Because there is no significant distance between the drill bit and sensor there is no reason to calculate velocity of vibration along the drill string but rather any loss would be negligible. The wired pipe then provides high-speed telemetry of information to the surface or other remote location created for the purpose of receiving that information. Since utilizing the drill bit as a seismic and/or acoustic source is indeed popular though burdened by the inherent inaccuracy associated with attenuation of the signal at a remote location, the configuration and method disclosed herein to telemeter at high speed information gained by sensor 22 adjacent the drill bit 12 without concern for attenuation of the signal over the length of the drill pipe will be very well received by the art.

Another method disclosed herein is of stopping the drill string momentarily and listening to the formation over a period of time. Immediately following the listening, the drill string may be reactivated and drilling continued. Such a method provides a significant advantage of periodically listening to the wellbore sounds without having to run a wireline or remove any other well equipment. This reduces costs associated with the reduction of drilling activity that is inherent in the prior art. In other words, drilling is maximized while downtimes minimized.

In another aspect, the configuration and method taught herein enables the monitoring of geophysical and or reservoir properties such as gas caps, water floods, water legs, and other general changes in the reservoir. Mapping of these conditions over time provides valuable information about the health of the formation and about its potential future production capability. The ability to monitor these conditions over time is enabled by the configuration illustrated in FIG. 1. Since the seismic and/or acoustic sensor 22 is placed directly on the drill pipe or production string and adjacent the drill bit 12 the operator can listen at anytime desired and transmit all information up the conductor 14 to a surface or other remote location in real time. This can be continued for as long as it is desired thereby providing, at for example a surface location, a real time picture in three dimensions of a geophysical property and the changes in that property over time. This is tremendously advantageous to the borehole operator enabling significantly more efficiency with respect to ultimate wellbore production.

In yet another aspect, the conductor 14 and its high-speed telemetry capability also facilitates improved use of geophones. As one of ordinary skill in the art will clearly understand, geophones function best when in solid contact with the formation. Because drill bits are rotated, geophones depending therefrom in a radially outward direction tend to be damaged relatively easily. Geophones, therefore, are sometimes eschewed in favor of hydrophones, which do not require contact with the formation. Hydrophones are effective for their intended purpose of measuring pressure. It will be recognized, however, that geophones in some applications are more useful because, for example, in a particular situation, displacement of the formation is more relevant than the pressure of the formation. Conductor 14 is again beneficial to the operator in connection with the configuration of FIG. 1 since geophones may be deployable at will from the surface location. In other words, a signal may be sent down conductor 14 that causes the geophones to be extended from the drill pipe into contact with the formation. This would, of course, be done while the drill bit remains stationary. In one embodiment, the geophones would be extended utilizing solenoids that are responsive to signals carried on conductor 14. Once the geophones are placed into solid contact with the formation, they can be used to measure formation displacement to the extent desired by the operator. When measuring is concluded, the geophones maybe retracted pursuant to another signal carried on conductor 14, or perhaps a lack of signal on conductor 14, placing them in a protected position while drilling recommences.

The astute reader may notice from the foregoing paragraph that another capability is enabled by the configuration of FIG. 1. That is that because of conductor 14, communication with downhole tools is possible. This communication can be used to activate or deactivate different tools, test certain components of the downhole tools monitor sensors designed to measure formation contact with other sensors, etc. This provides for the first time with respect to seismic and/or acoustic while drilling the real-time ability to watch and modify both the tool and the downhole environment.

In another aspect, it is noted that because of the conductor 14, multiple sensors may be used in the downhole environment since signals may be piggybacked on one another on the conductor 14, and due to the speed with which conductor 14 can convey information, more sensors can over time be addressed and transmit information to the surface location. Moreover, because sensors may be distributed along the drill pipe 10, processes such as Q measurement may be affected more efficiently since the high frequency attenuation inherent in this measurement method can be measured more accurately over specific smaller distances over the length of the drill pipe.

While the invention has been described with reference to exemplary embodiments, it will be understood that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A seismic and/or acoustic while drilling configuration comprising:
a high speed telemetry arrangement;
at least one seismic and/or acoustic energy sensor in communication with the high speed telemetry arrangement; and
at least one seismic and/or acoustic energy source capable of producing at least one seismic and/or acoustic energy signal receivable by the at least one seismic and/or acoustic energy sensor.

2. The seismic and/or acoustic while drilling configuration as claimed in claim 1, wherein the high-speed telemetry arrangement is a wired pipe.

3. The seismic and/or acoustic while drilling configuration as claimed in claim 1, wherein the at least one seismic and/or acoustic energy sensor is a plurality of sensors.

4. The seismic and/or acoustic while drilling configuration as claimed in claim 1, wherein the plurality of sensors are located along and axial length of the high speed telemetry arrangement.

5. The seismic and/or acoustic while drilling configuration as claimed in claim 1, wherein the seismic and/or acoustic energy source is a drill bit.

6. The seismic and/or acoustic while drilling configuration as claimed in claim 1, wherein the seismic and/or acoustic energy source is an active source.

7. The seismic and/or acoustic while drilling configuration as claimed in claim 1, wherein the seismic and/or acoustic energy source is a passive source.

8. A method for monitoring a formation while drilling comprising:
stopping movement of the drill string;
listening for sounds of the formation without running an additional tool; and
recommencing movement of the drill string.

9. A method for 4D monitoring a formation after drilling comprising:
introducing into a borehole the configuration of claim 1;
initiating a seismic and/or acoustic signal from the seismic and/or acoustic source; and
monitoring the signal over time.

10. The method for 4D monitoring a formation after drilling as claimed in claim 9, wherein the method further comprises transmitting the monitored signal in real time to a remote location.

11. The method for 4D monitoring a formation after drilling as claimed in claim 10, wherein the method further comprises constructing a three-dimensional model based upon the real-time signal.

12. A method for at least one of monitoring, adapting and operating in the wellbore while drilling comprising:
introducing into a borehole the configuration of claim 1;
sending a signal over the high-speed telemetry arrangement to a sensor in the downhole environment;
causing the sensor to deploy into contact with a target formation;
measuring a parameter of the formation with the sensor; and
telemetering information measured by the sensor to a remote location.

13. The method for monitoring displacement in the wellbore while drilling as claimed in claim 12 wherein the method further comprises retracting the sensor.

14. A method for monitoring a wellbore while drilling comprising:
measuring seismic and/or acoustic energy at a downhole location; and
transmitting a signal representative of the seismic and/or acoustic energy through a high-speed telemetry arrangement to a remote location.

15. The method for monitoring a wellbore while drilling as claimed in claim 14 wherein the method further comprises initiating a seismic and/or acoustic signal from a seismic and/or acoustic energy source.

16. The method for monitoring a wellbore while drilling as claimed in claim 14 wherein the method further comprises:
receiving the transmitted signal at a control location; and
adjusting at least one parameter of at least one of a borehole or a system executing the measuring or the transmitting.

17. The method for monitoring a wellbore while drilling as claimed in claim 16 wherein the adjusting includes monitoring background noise to identify a period where noise is low and then surveying a formation.
